(19) United States
(12) Patent Application Publication
(10) Pub. No.: US 2024/0424826 A1
(43) Pub. Date: Dec. 26, 2024

(54) Break-Proof Interchangeable Pen Clip

(71) Applicant: Andrew C. Gilliland, Tampa, FL (US)

(72) Inventor: Andrew C. Gilliland, Tampa, FL (US)

(21) Appl. No.: 18/740,552

(22) Filed: Jun. 12, 2024

Related U.S. Application Data
(60) Provisional application No. 63/510,229, filed on Jun. 26, 2023.

(51) Int. Cl. B43K 25/02

(52) U.S. Cl. CPC B43K 25/024

(57) ABSTRACT

The Break-Proof Interchangeable Pen Clip is an innovative accessory designed to securely attach to writing instruments, preventing detachment and enhancing durability. The clip features a circular ring that fits around a high-quality metal screw, secured under a removable button casing at the pen's top. This design allows users to easily interchange and customize the clip's style or color. Made from robust alloy metal, the clip ensures a firm grip around the pen's body and can attach to various surfaces like shirt pockets, binders, and seat belts. The clip's arched surface design enhances its ability to remain securely fastened, minimizing the risk of accidental detachment. This invention combines functionality and aesthetic appeal, offering a reliable solution to maintain the integrity and utility of pen clips while providing opportunities for personalization.

### BACKGROUND

### Field of the Invention

The present invention pertains to the field of writing instruments and accessories, specifically to an innovative design of a break-proof, interchangeable pen clip. This clip is uniquely designed to be securely attached to pens and similar instruments, providing enhanced durability and customization. The invention focuses on improving the attachment mechanism of pen clips, ensuring they remain firmly in place during use, thereby preventing detachment and potential loss.

### Description of the Related Art

Pen clips have long been indispensable accessories in the world of stationery, providing users with a convenient way to secure their writing instruments to a variety of surfaces such as pockets, binders, and notebooks. Historically, these clips have been integral to ensuring that pens are easily accessible and less likely to be misplaced or lost. However, the traditional approach to pen clip design often involves permanently affixed clips, which limit the potential for customization and replacement. As users increasingly seek both functionality and personalization in their everyday tools, the demand for innovative pen clip designs has grown.

The role of a reliable pen clip extends beyond mere convenience; it is crucial for the organization and efficiency of students, professionals, artists, and anyone who relies on writing instruments regularly. A secure clip prevents loss, which can be particularly frustrating during critical moments when a pen is urgently needed. Moreover, a well-designed clip can enhance the pen's ergonomic qualities, making it more comfortable to use and carry. Customization options for the clip can also cater to individual preferences, allowing each user to have a pen that not only performs well but also satisfies their aesthetic desires and personal style.

The stationery products market, valued at USD 90.6 billion in 2020, reflects the substantial demand for high-quality writing instruments and accessories. The forecasted compound annual growth rate (CAGR) of 4.1% from 2021 to 2028 underscores the ongoing expansion and innovation within this industry. Surveys have shown that over 60% of professional users prefer pens with attached clips due to the convenience and security they provide. The rise in demand for customizable pen clips, evidenced by a 15% increase in annual sales, highlights the growing consumer interest in personalization and unique product designs.

In recent years, several innovations have emerged in the field of pen clips. For instance, magnetic pen clips have been introduced, providing a strong and reliable hold without the need for traditional mechanical attachments. This technology eliminates common issues such as clip breakage or loss of grip. Manufacturers have also experimented with advanced materials like titanium and carbon fiber, creating clips that combine durability with a sleek aesthetic. Additionally, the rise of eco-friendly products has led to the development of clips made from recycled and sustainable materials, catering to the environmentally conscious consumer.

By looking at prior art multiple advancements have been seen. For instance, a KR patent 1,009,15414B1 relates to detachable writing supplies on writing instruments. The writing instruments detachable to the writing instrument according to the present invention, the coupling ring formed detachably on the pen holder; A clip formed on the coupling ring; Nib lid; And a connecting portion connecting the pen nib lid to an upper portion of the coupling ring and configured to be rotatable between the nib lid and the coupling ring. According to the present invention, it is possible to provide a writing instrument that can be detachably attached to a writing instrument that can be used by simply attaching a clip to a writing instrument without a clip, and can also be used by easily attaching a clip and a nib lid to a writing instrument without a clip and a nib lid. It is possible to provide a writing instrument that is removable to the writing instrument.

A U.S. patent 2,006,0222449 relates to writing implement with detachable stylus. The multifunction handheld writing instrument includes a combination device of a pocket clip and a removable stylus. The pocket clip has a first part that attaches to an elongated handheld instrument, and a elongated second part which includes a distal stylus tip. The proximal end of the second part of the clip engages an attachment means on the body. When the clip is in a first position, it is biased against the writing instrument body and may be used for attachment to, for example, a shirt pocket. The clip may be completely detached from the first part and used separately as a stylus, or in a second position, whereby the elongated second part projects axially outward and may be used as a stylus. An advantage of the clip it allows the user to readily switch back and forth between writing with a ball point pen tip and writing with the stylus.

A U.S. patent 7,287,925B2 relates to writing instrument with letter opening pocket clip. The improvement to a writing instrument with a pocket clip and an integrated letter-opening blade. The improvement consists of locating the letter-opening blade in the pocket clip of the pen. The blade is prevented from cutting the pocket of the user due to a blade protector that is mechanically linked to the mechanism that extends and retracts with the marking or writing tip. In an alternate embodiment, the blade is located on the opposite side of the pocket clip. The extending and retracting mechanism can be a variety of types including twist, press, sliding.

Despite these advances, users continue to encounter significant challenges with existing pen clip designs. Clips that are prone to snapping off or losing their grip over time still pose a problem, especially for professionals who rely on their pens being securely fastened to their attire or work materials. The inability to replace permanently affixed clips without discarding the entire pen not only limits the longevity of the product but also raises environmental concerns due to increased waste. Furthermore, the lack of customization options in many traditional designs fails to meet the modern user's desire for personalization.

The proposed invention offers a novel solution to these persistent issues with a removable pen clip featuring an attached circular “O” ring that can be secured to a pen or similar instrument. This innovative design employs a rotating screw mechanism to ensure a firm and secure attachment, significantly reducing the likelihood of detachment during use. The “O” ring is engineered to allow for easy interchangeability, empowering users to customize the clip's style and color according to their preferences. This feature not only adds a personal touch but also enhances the pen's versatility and practicality.

This innovative clip design effectively addresses the market's unmet needs for durability, customization, and secure attachment. By using a robust screw mechanism, our clip provides a dependable solution that minimizes the risk of breakage, thus prolonging the pen's usable life. The interchangeable nature of the “O” ring allows users to refresh and personalize their pen's appearance effortlessly, aligning with the current consumer trends towards customization and sustainability. Ultimately, our invention fills a critical gap in the market by combining superior functionality with aesthetic flexibility, offering a valuable accessory that stands out among existing products.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a break-proof design, wherein the pen clip ensures longevity and resilience, minimizing the risk of detachment or breakage during use.

It is also the objective of the invention to offer customization options, wherein with its interchangeable features, users can easily personalize their writing instruments by selecting different clip styles or colors to suit their preferences.

Another object of this invention is to provide secure attachment, wherein the unique “O” ring and rotating screw mechanism securely fasten the clip to the pen, preventing accidental detachment and loss.

It is an object of the invention to simplify maintenance, wherein the removable button casing grants access to the high-quality metal screw, facilitating easy installation, removal, and interchangeability of the pen clip.

It is also the objective of the invention to ensure functional utility: By preventing breakage and detachment, the pen clip enhances the overall functionality of writing instruments, offering a reliable solution for everyday use.

It is moreover the objective of the invention to improve aesthetics, wherein with its sleek design and attention to detail, the pen clip enhances the visual appeal of writing instruments, adding a touch of elegance to everyday accessories.

It is also the objective of invention to enhance versatility, wherein the clip's arched surface design enables it to be securely attached to a variety of surfaces, including shirt pockets, binders, and seat belts, providing users with greater flexibility in usage.

It is another object of the invention to promote convenience, wherein users can easily attach the pen clip to their preferred writing instrument, ensuring easy access and secure storage while on the go.

Yet another object of the present invention is to reduce the likelihood of loss due to its secure attachment mechanism, the pen clip minimizes the risk of accidentally losing writing instruments, providing peace of mind to users.

It is a further aspect of the present invention to enhance user satisfaction, by addressing common issues associated with traditional pen clips and offering innovative solutions, the invention aims to improve user experience and satisfaction with writing instrument accessories.

Thus, it is the objective to provide an assembly that can be attached to any type of dryer to provide drying functionality. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the exploded view of the Break-Proof Interchangeable Pen Clip, as per an embodiment of the present disclosure.

FIG. 2 illustrates the structural configuration of the Break-Proof Interchangeable Pen Clip, as per an embodiment of the present disclosure.

FIG. 3 illustrates another view of the Break-Proof Interchangeable Pen Clip, as per an embodiment of the present disclosure.

FIG. 4 illustrates the top view of the installed Break-Proof Interchangeable Pen Clip, as per an embodiment of the present disclosure.

FIG. 5 illustrates a closeup view of the installed Break-Proof Interchangeable Pen Clip, as per an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, theterm “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The Break-Proof Interchangeable Pen Clip represents a significant advancement in the field of writing instrument accessories, particularly pen clips. Traditional pen clips often suffer from detachment or breakage during use, leading to inconvenience and potential loss of the pen. Recognizing this common issue, the present invention aims to provide a solution that ensures the secure attachment of pen clips while offering customization options for users. By introducing a break-proof design with interchangeable features, this invention addresses the limitations of conventional pen clips and enhances both functionality and aesthetic appeal.

The Break-Proof Interchangeable Pen Clip as per its preferred embodiments, comprises several key components designed to optimize its performance and versatility. At its core is a durable clip body constructed from high-quality alloy metal, ensuring longevity and resilience. Attached to the clip body is a unique “O” ring, meticulously engineered to fit securely around the circumference of the pen. This “O” ring plays a pivotal role in preventing detachment by firmly securing the clip to the pen during use.

As per its preferred embodiments, facilitating the attachment mechanism is a rotating screw mechanism, strategically integrated into the design. Housed under a removable button casing at the top of the pen, this mechanism allows users to easily install, remove, and interchange the pen clip as desired. By providing access to the high-quality metal screw, the button casing simplifies maintenance and customization, enabling users to personalize their writing instruments with different clip styles or colors.

As per its preferred embodiments, the Break-Proof Interchangeable Pen Clip offers more than just functional utility; it also enhances the aesthetic appeal of writing instruments. With its sleek design and attention to detail, the clip complements the overall look of pens while providing a secure grip on various surfaces. The clip's arched surface design further enhances its versatility, allowing it to be attached to shirt pockets, binders, seat belts, and other materials with at least 2 inches of secure space.

As per its preferred embodiments, the Break-Proof Interchangeable Pen Clip represents a significant advancement in writing instrument accessories. Its innovative design addresses the shortcomings of traditional pen clips by providing enhanced durability, customization options, and aesthetic appeal. With its durable construction, secure attachment mechanism, and versatile design, this invention offers users a practical solution to maintain the integrity and functionality of pen clips while adding a touch of personalization to their writing instruments.

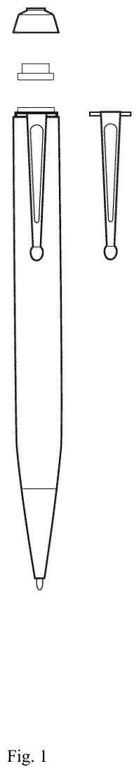

The invention can be further understood by the provided figures. FIG. 1 shows an exploded view of the break-proof interchangeable pen clip. This illustration presents an exploded view of the Break-Proof Interchangeable Pen Clip, showcasing its various components disassembled to highlight their individual features and assembly sequences. The view clearly delineates each part, including the durable clip body, the unique “O” ring, the rotating screw mechanism, and the removable button casing. This perspective allows for a comprehensive understanding of how each element fits together to form the complete pen clip assembly, emphasizing the precision engineering involved in its design.

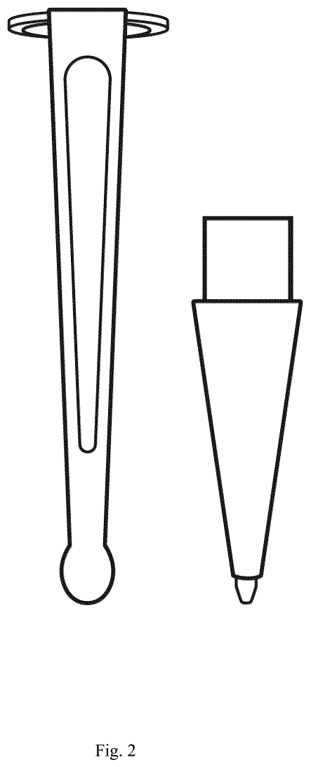

FIG. 2 shows the Structural Configuration of the Break-Proof Interchangeable Pen Clip. In this figure, the structural configuration of the pen clip is depicted in its fully assembled state. It provides a side view of the pen clip attached to a pen, illustrating the integration of the key components. The durable clip body is prominently featured, with the “O” ring shown securing the clip firmly around the pen's circumference. The rotating screw mechanism and the button casing are also visible, demonstrating how they contribute to the overall stability and functionality of the pen clip.

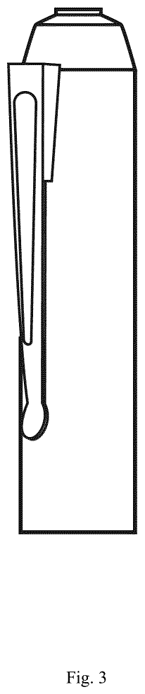

FIG. 3 shows another view of the break-proof interchangeable pen clip. This illustration offers a different perspective on the Break-Proof Interchangeable Pen Clip, likely from an angled or side view, providing additional visual context. This view may highlight specific design features or aspects of the pen clip that are not as evident in other illustrations, such as the curvature of the clip body or the precise fit of the “O” ring around the pen. This perspective reinforces the robustness and ergonomic design of the pen clip.

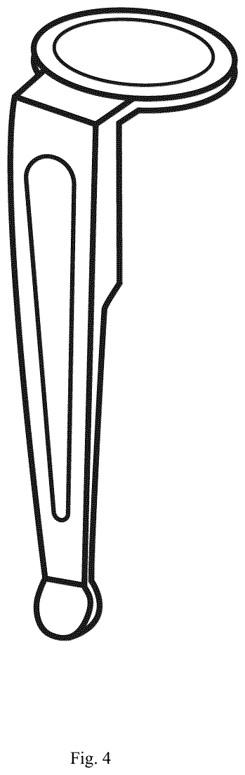

FIG. 4 shows top view of the installed break-proof interchangeable pen clip. The top view shown in this figure focuses on the appearance and configuration of the pen clip when installed on a pen. It provides a clear view of the button casing and how it integrates with the pen's design. This view emphasizes the seamless integration and the low-profile nature of the pen clip, ensuring it does not obstruct writing or handling of the pen. The top view also highlights the aesthetic appeal of the clip, showcasing its sleek design.

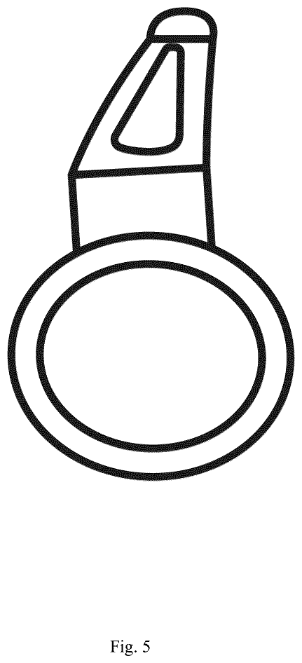

FIG. 5 shows the closeup view of the installed break-proof interchangeable pen clip. A close-up view is presented in this illustration, zooming in on the details of the installed pen clip. This detailed view allows for an in-depth examination of the materials and craftsmanship involved. The high-quality alloy metal of the clip body, the secure fit of the “O” ring, and the precision of the rotating screw mechanism are all clearly visible. This perspective underscores the durability and meticulous engineering of the pen clip, reinforcing its break-proof and interchangeable qualities.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A break-proof interchangeable pen clip comprising:
a clip body;
an “O” ring attached to the clip body;
a rotating screw mechanism for securing the clip to a pen or other instrument.

2. The pen clip of claim 1, wherein the removable button casing allows access to the high-quality metal screw.

3. The pen clip of claim 1, wherein the “O” ring is designed to fit securely around the circumference of the pen.

4. The pen clip of claim 1, wherein the “O” ring ensures the clip remains firmly attached during use, preventing detachment.

5. The pen clip of claim 1, wherein the clip body is made from a durable alloy metal.

6. The pen clip of claim 1, wherein the clip is interchangeable, allowing for customization of style and color.

7. The pen clip of claim 1, wherein the clip body is designed to be attached to various surfaces including shirt pockets, binders, and seat belts.

8. The pen clip of claim 1, wherein the clip body is at least 2 inches long.

9. The pen clip of claim 1, wherein the arched surface design of the clip body enhances its ability to remain securely fastened to surfaces.

10. The pen clip of claim 1, wherein the pen body to which the clip is attached is also constructed from high-quality alloy metal.

11. The pen clip of claim 1, wherein the pen tip houses the ink for the writing instrument.

12. The pen clip of claim 1, wherein the rotating screw mechanism is housed under a removable button casing.

13. The pen clip of claim 1, wherein the clip can be easily removed and reattached using the screw mechanism.

14. The pen clip of claim 1, wherein the clip's design provides an aesthetically pleasing appearance.

15. The pen clip of claim 1, wherein the clip enhances the functional utility of the pen by preventing breakage and detachment during use.
